(19) United States
(12) Patent Application Publication
(10) Pub. No.: US 2005/0102148 A1
(43) Pub. Date: May 12, 2005

(54) System and method for providing programming on vehicle radio or audio/video decice in response to voice commands

(76) Inventor: John L. Rogitz, San Diego, CA (US)

Correspondence Address: John L. Rogitz, Esq.;ROGITZ & ASSOCIATES, Suite 3120, 750 "B" Street, San Diego, CA, 92101, US

(21) Appl. No.: 10/705,596

(22) Filed: Nov. 10, 2003

(51) Int. Cl. G10L 11/00

(52) U.S. Cl. 704/275

(57) ABSTRACT

A vehicle radio and/or audio-video player can be tuned to a channel in response to a voice command by accessing a local database or the Internet to determine which channel plays content most closely matching the voice command, e.g., “play classical music”.

### FIELD OF THE INVENTION

The present invention relates generally to vehicle radio and audio-video systems.

### BACKGROUND

It is often the case that an occupant of a vehicle wishes to hear a particular program or type of program on the radio, but does not know which channel to select, particularly when driving in an area beyond the occupant's familiar territory. For example, an occupant might want to hear classical music, but not know what channel in the local area plays classical.

Further, the present invention recognizes that in addition to playing the radio, many vehicles now come equipped with audio-video devices such as small television sets that suffer from the same drawbacks noted above, namely, that an occupant may wish to see a particular show or type of show but not know what channel to tune in to. Moreover, some desired content might not be available at all on local radio/TV channels. The present invention recognizes how nice it would be if an occupant of a vehicle could nonetheless play a desired program or type of program on the radio or TV, just by expressing the desired program type.

### SUMMARY OF THE INVENTION

A system includes a vehicle and at least one player on the vehicle and selected from the group consisting of: radios, and audio-video players. A processor receives voice commands and in response thereto determines content and/or a channel for the player to play.

The preferred processor may access a database onboard the vehicle to determine a channel to tune the player to in response to the voice command. The non-limiting processor may access a database onboard the vehicle to determine content to display on the player, or it may wirelessly access the Internet to obtain content and channel information that satisfies the voice command. If desired, the processor can cause the player to play content from the Internet, in response to the voice command. Or, the player can be a radio and the processor tunes the radio to a channel in response to the voice command.

In another aspect, a system for a vehicle includes player means mountable onboard the vehicle for playing audio and/or audio-video content, and means for receiving a voice command. The system also includes at least one of: means for tuning the player to a channel in response to the voice command, and means for determining content to display on the player in response to the voice command.

In yet another aspect, a method for tuning a radio in a vehicle includes issuing a voice command, and digitizing the voice command to render a digitized command. The method also includes correlating the digitized command to a radio channel, and automatically tuning the radio to the radio channel. The correlating act may be undertaken using vehicle position information, if desired.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an exemplary embodiment of the present system; and

FIG. 2 is a flow chart illustrating preferred non-limiting logic.

### DETAILED DESCRIPTION OF THE PREFERRED EMBODIMENT

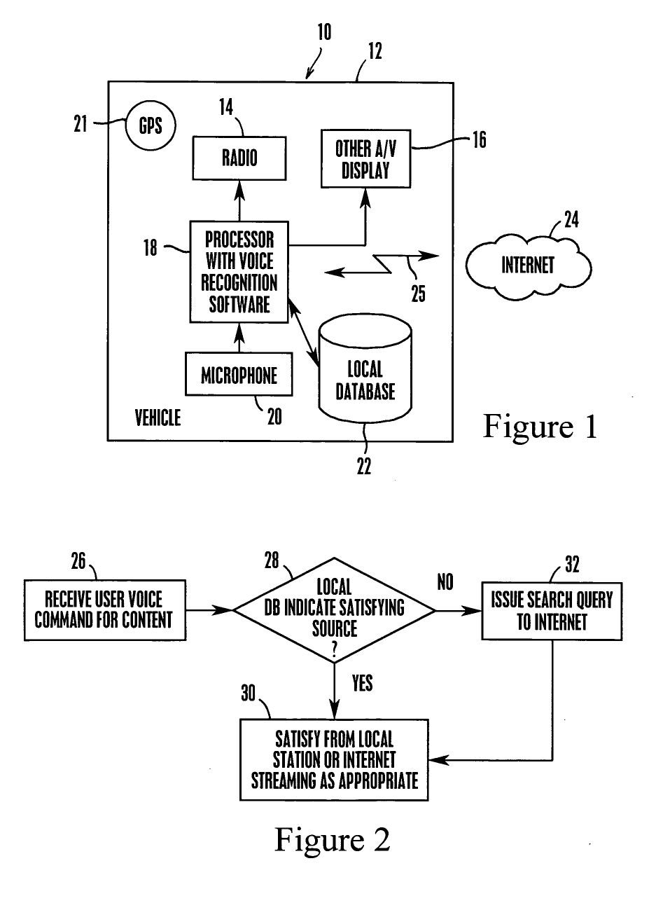

Referring initially to FIG. 1, a system is shown, generally designated 10, which includes a vehicle 12 having a conventional radio 14, although it is to be understood that the below-described processor could be embodied in the radio 14 if desired. The vehicle 12 may also have an audio-video player 16 such as a TV display, personal digital recorder, VCR player, DVD player, and the like that can play audio-video content such as TV shows and movies.

A processor 18 with voice recognition software is in the vehicle 12, and may be embodied by the vehicles' onboard engine control module, modified in accordance with principles set forth herein. Or, the processor 18 may be separate from the ECM. It is to be understood that while for simplicity FIG. 1 shows a processor 18, the processor 18 may include a digital processor proper as well as ancillary analog and transformation circuitry, including, e.g., circuitry for receiving signals from a microphone 20 to digitize the signals for voice recognition as well as circuitry to convert digital signals to analog for radio frequency transmission to the Internet. The processor 18 may also receive position information from a GPS system 21.

The processor 18 may communicate with a local data store 22 such as a database or file system for purposes to be shortly disclosed. Also, as mentioned above the processor 18 may communicate with the Internet 24 over a wireless link 25, in which case the processor 18 includes wireless communication circuitry known in the art, e.g., CDMA/TDMA/GSM circuitry, Bluetooth circuitry, Wi-fi circuitry, etc., as well as browser software.

FIG. 2 shows exemplary non-limiting logic that is used by the system 10 to play desired content on the radio 14 and/or audio-video player 16. An occupant's voice command is received at block 26. For example, the occupant's voice command might be a non-channel number command such as “classical music”, evincing a desire on the part of the occupant to hear classical music. Or, the occupant might command “Beethoven” to be played, or “Rush Limbaugh”. Of course, the voice command might be more direct, if the occupant knows the desired channel, e.g., the occupant might say “one oh two point seven FM” to cause the radio to tune to 102.7 MHz.

If desired, a convention can be employed to alert the voice recognition software that a command is being issued, e.g., the occupant might precede the desired type of content or channel number with the key words “radio, play” followed by the desired content. If the occupant wants to see a particular TV program on the A-V player 16, he might say, “TV play The Simpsons®” or “TV play Britney Waives the Rules”.

Proceeding to decision diamond 28, the processor 18 receives the voice command and using voice recognition software determines what phonemes/words were uttered to use the phonemes/words (and, if desired, location information from the GPS 21) as entering arguments to access the local data store 22. If the processor 18 determines that the phonemes/words can be matched to an entry in the data store, which is correlated to channel numbers and locations, the processor moves to block 30 to satisfy the request by tuning the radio 14/player 16 as appropriate to the channel indicated in the data store 22 for the particular location of the vehicle 12. For example, “Beethoven” and like commands (e.g., “Mozart”, “classical”) may be correlated to a classical music channel “A” when the GPS information indicates that the vehicle is in the Phoenix area, and to classical music channel “B” when the GPS information indicates that the vehicle is in the New York area.

The data store 22 may also contain entries to TV stations when the occupant wants to play A-V content on the player 16. And, the data store 22 may contain entries to Internet content by, e.g., URL so that if the requested content is not supplied by local programming, the processor 18 may access the Internet 24 and cause the content to be streamed or otherwise downloaded to the vehicle 12 for display thereof on the radio 14 or player 16 as appropriate.

On the other hand, if no matching entries (or “close” entries as might be determined by software that would correlate, for example, the phonemes “classic” to a data store entry of “classical”) in the local data store 22 are found at decision diamond 28, the logic could proceed to block 32 to generate an Internet search query. For example, at block 32 the processor 18 might use its browser to enter the Google® site and enter, as a query, the phonemes/words received at block 26. The processor 18 might then access the first result returned by the search to locate a .wav file or .mpg file most closely matching the voice command. Or, the Internet search might simply inform the processor 18 of the local radio or TV station that plays the desired content, for tuning the radio 14/player 16 as appropriate at block 30.

While the particular SYSTEM AND METHOD FOR PROVIDING PROGRAMMING ON VEHICLE RADIO OR AUDIO/VIDEO DEVICE IN RESPONSE TO VOICE COMMANDS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A system, comprising:
a vehicle;
at least one player on the vehicle and selected from the group consisting of: radios, and audio-video players; and
at least one processor for receiving at least one voice command and in response thereto determining at least one of: content, and a channel, for the player to play.

2. The system of claim 1, wherein the processor accesses a database onboard the vehicle to determine a channel to tune the player to in response to the voice command.

3. The system of claim 1, wherein the processor accesses a database onboard the vehicle to determine content to display on the player.

4. The system of claim 1, wherein the processor wirelessly accesses the Internet to obtain at least one of: content, and channel information, satisfying the voice command.

5. The system of claim 4, wherein the processor causes the player to play content from the Internet, in response to the voice command.

6. The system of claim 1, wherein the player is a radio and the processor tunes the radio to a channel in response to the voice command.

7. The system of claim 6, wherein the processor accesses a database to determine the channel to tune the radio to.

8. A system for a vehicle, comprising:
player means mountable onboard the vehicle for playing audio and/or audio-video content;
means for receiving a voice command; and
at least one of:
means for tuning the player to a channel in response to the voice command; and
means for determining content to display on the player in response to the voice command.

9. A method for tuning a radio in a vehicle, comprising:
issuing a voice command;
digitizing the voice command to render a digitized command;
correlating the digitized command to a radio channel; and
automatically tuning the radio to the radio channel.

10. The method of claim 9, wherein the correlating act is undertaken using vehicle position information.

11. The system of claim 1, wherein the voice command is a non-channel number voice command.

12. The system of claim 8, wherein the voice command is a non-channel number voice command.

13. The method of claim 9, wherein the voice command is a non-channel number voice command.
